(19) United States
(12) Patent Application Publication
(10) Pub. No.: US 2026/0356166 A1
(43) Pub. Date: Nov. 12, 2026

(54) AIR OUTLET ARRANGEMENT FOR A VEHICLE

(71) Applicant: AUDI AG, lngolstadt (DE)

(72) Inventors: Michael EBERLE, Stammham (DE); Erik FRIEBE, Oberdolling (DE); Alexander HEINZELMANN, Fürth (DE); Maximilian KÖCHER, Stammham (DE); Nikolaus PELLER, Freising (DE); Nicol PRINCIPI, lngolstadt (DE); Bernd SCHEIDERER, Allersberg (DE); Roland WEBER, Großmehring (DE)

(73) Assignee: AUDI AG, lngolstadt (DE)

(21) Appl. No.: 19/471,974

(22) PCT Filed: Apr. 8, 2024
(86) PCT No.: PCT/EP2024/059449

§ 371 Date: Oct. 2, 2025

(30) Foreign Application Priority Data
Jun. 2, 2023 (DE) 102023114515.0

(51) Int. Cl. B60H 1/24; B60H 1/34; B60Q 3/76

(52) U.S. Cl. CPC B60H 1/242; B60H 1/3414; B60Q 3/76

(57) ABSTRACT

An air outlet arrangement for a vehicle includes at least one air outlet and at least one evaluation and control unit. The at least one air outlet has an air outlet opening to direct an air flow into an interior, at least one controllable adjustment device to adjust an outflow direction of the air flow directed into the interior and its target region, and at least one projection device to generate and output at least one light beam The at least one evaluation and control unit correspondingly control the at least one controllable adjustment device of the at least one air outlet based on at least one user input and to direct the air flow to the predetermined target region. The evaluation and control unit control the at least one projection device of the at least one air outlet in different operating modes.

### FIELD

The invention relates to an air outlet arrangement for a vehicle.

### BACKGROUND

Air outlet arrangements for vehicles with at least one air outlet are known in numerous variations. In the case of air outlet arrangements known from the prior art, manually operated air outlets are generally used, in which the outflow direction of an air flow directed into the interior through the corresponding air outlet opening is changed directly at the air outlet, for example via an adjustment slide. This creates a logical link between the user's action and the system's response by changing the air outflow direction. The user can, for example, direct the airflow direction exactly to a part of the body where he or she wants the airflow to hit. In the case of air outlets whose outflow direction of the air flow is adjusted by means of controllable adjustment devices and which can no longer be operated manually via an adjustment element directly on the air outlet, such a logical connection between the user's action and the system's reaction is no longer possible. Such a spatial separation of the control device from the air outlet makes it significantly more difficult to precisely adjust the position of the air flow of the air outlet.

DE 10 2006 011 125 A1 discloses an air outlet for a motor vehicle which allows a visual assessment of its operating status even in low ambient light. For this purpose, at least one component of the air outlet is formed at least partially from a light-conducting material. Light can be supplied to this component. In addition, the component is visible from a space to be air ventilated by the air outlet and can be hit by an air flow flowing out through the air outlet.

From DE 10 2020 128 614 A1, an air outlet for an air duct of a vehicle is known, comprising an air outlet opening, a housing delimiting the air outlet opening and an optical display device which is designed to display set parameters of an air flow flowing out of the air outlet opening. The optical display device comprises at least one projection device which displays the set parameters of the air flow as animated projections on at least one projection surface arranged in the region of the air outlet.

### SUMMARY

The invention is based on the object of providing an air outlet arrangement for a vehicle, having at least one air outlet, which simplifies a targeted adjustment of an air outlet direction of an air flow flowing out of the at least one air outlet and increases the ease of use of the air outlet arrangement.

In order to provide an air outlet arrangement for a vehicle, having at least one air outlet, which simplifies a targeted adjustment of an air outlet direction of an air flow flowing out of the at least one air outlet and increases the ease of use of the air outlet arrangement, the at least one air outlet of the air outlet arrangement comprises an air outlet opening designed to direct an air flow into an interior, at least one controllable adjustment device designed to adjust an air outlet direction of the air flow directed into the interior and its target region, and at least one projection device designed to generate and output at least one light beam. In this case, at least one evaluation and control unit is designed to control the at least one controllable adjustment device of the at least one air outlet accordingly based on at least one user input and to direct the air flow to the specified target region. The at least one evaluation and control unit is further designed to operate the at least one projection device of the at least one air outlet in different operating modes. The at least one projection device of the at least one air outlet is designed to generate the at least one light beam with a high intensity as a spot light beam in a first operating mode and to output it in such a way that the at least one light beam follows the direction of the output air flow and directly visualizes the air flow and generates at least one projection at the target region of the air flow.

In embodiments of the air outlet arrangement according to the invention, the at least one light beam and the at least one projection can, for example, be effective in such a way that the at least one light beam extends the outflowing air flow along the outflow axis, so that a target region or impact region of the air flow, for example on the body of the vehicle occupants, but also on specific surfaces such as side windows, via which at least one projection can be directly recognized. The at least one light beam can preferably be projected in the form of a ring at the target region or impact region of the air flow, so that the projection then directly illuminates the vehicle occupant and thus directly visualizes the direction of the air flow.

The direct visibility of the outflow direction of the air flow using optical target points leads to a significant simplification of the alignment of the air flow of the at least one air outlet, the outflow direction of which can be adjusted via at least one adjustment device. The at least one adjustment device can, for example, comprise a first actuator motor and at least one first air guide element which is adjustable by the first actuator motor, and a second actuator motor and at least one second air guide element which is adjustable by the second actuator motor. In this case, a lateral deflection of the air flow to the left or right is possible via the first actuator motor and the at least one first air guide element. The air flow can be redirected upwards or downwards via the second actuator motor and at least one second air guide element.

In an advantageous embodiment of the air outlet arrangement, the at least one evaluation and control unit can be designed to operate the at least one projection device of the at least one air outlet in the first operating mode during an adjustment process of the outflow direction of the air flow directed into the interior. This can reduce the distraction of the occupants while driving due to the visible light rays when adjusting the air flow, while still simplifying the air flow adjustment. In addition, after the setting process has been completed, a waiting time window can be specified before the first operating mode is ended.

In a further advantageous embodiment of the air outlet arrangement, the at least one projection device of the at least one air outlet can be further designed to generate the at least one light beam with a lower intensity as a diverging light beam in a second operating mode and to output it in such a way that the at least one light beam illuminates the air outlet opening of the at least one air outlet with no projection. For example, a ring-shaped illumination of the outlet opening can be created at the edge of the outlet opening without any projection taking place.

In a further advantageous embodiment of the air outlet arrangement, the at least one projection device can be further designed to generate the at least one light beam of the at least one air outlet with the high intensity in a third operating mode and to output it with a constant output direction or with an output direction changing according to a predetermined movement pattern, so that at least one projection can be generated in the interior. In this case, the at least one evaluation and control unit can be designed to operate the at least one projection device before starting or after operation of the vehicle in the third operating mode. For example, appealing moving or static scenarios are conceivable, such as a disco mode with multiple light beams generated as high-intensity spotlights or the projection of rings in the ceiling of the vehicle interior as a welcoming or farewell scenario. In this case, the at least one projection device of the at least one air outlet can be further designed to specify an output color of the generated at least one light beam. This allows the spotlight beams or rings to be generated and output in different colors.

In a further advantageous embodiment of the air outlet arrangement, the at least one projection device can be designed to visualize a set strength of the air flow emitted by the at least one air outlet via the intensity of the at least one light beam during the second operating mode. Additionally or alternatively, the at least one projection device can be designed to visualize a set temperature via different color tones of the at least one light beam during the second operating mode. Thus, during the second operating mode, by the illumination in the air outlet and the intensity of the illumination, the strength of the emitted air flow, as well as the outlet temperature of the emitted air flow can be visualized using different colors.

In a further advantageous embodiment of the air outlet arrangement, different colors can be assigned to multiple air outlets, so that the projection devices of the individual air outlets generate and emit the corresponding at least one light beam with the assigned color during the first operating mode. The possibility of multi-colored projection allows the various air outlets installed in the vehicle to be directly assigned and differentiated.

In a further advantageous embodiment of the air outlet arrangement, at least one operating device, which is arranged separately from the at least one air outlet, can be designed to receive at least one user input and to output at least one corresponding operating signal to the evaluation and control unit. The at least one operating device can be designed, for example, as a menu-driven screen with a touch-sensitive surface or as a so-called “touch screen” via which manual operating inputs are possible.

The features and combinations of features mentioned above in the description as well as the features and feature combinations mentioned below in the description of the figures and/or merely shown in the figures may be used not only in the combination specified, but also in other combinations or alone, without departing from the scope of the invention. The invention should therefore also be considered to comprise and disclose embodiments that are explicitly not shown or explained in the figures, but emerge and can be created from the explained embodiments by separate feature combinations.

### BRIEF DESCRIPTION OF THE FIGURES

An exemplary embodiment of the invention is illustrated in the drawings and will be described in greater detail in the following description. In the drawings, identical reference numerals designate components or elements that perform identical or analogous functions. In the figures:

FIG. 1 shows a schematic and partial representation of a vehicle interior having an exemplary embodiment of an air outlet arrangement according to the invention for a vehicle; and

FIG. 2 shows a schematic block diagram of essential components of the air outlet arrangement according to the invention for a vehicle from FIG. 1.

### DETAILED DESCRIPTION

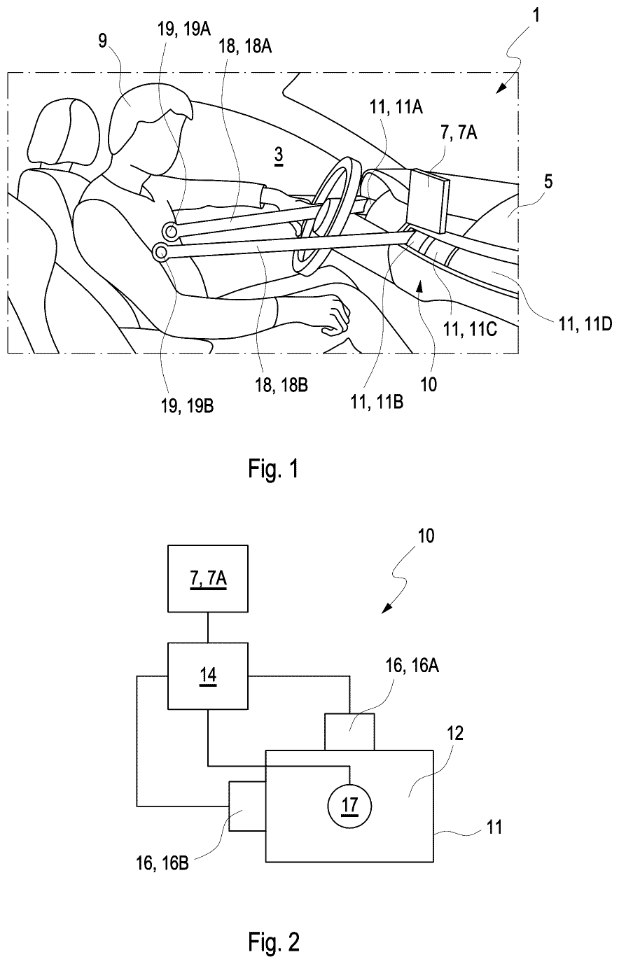

As can be seen from FIGS. 1 and 2, the illustrated exemplary embodiment of an air outlet arrangement 10 according to the invention for a vehicle 1 has at least one air outlet 11 and at least one evaluation and control unit 14. The at least one air outlet 11 comprises an air outlet opening 12 which directs an air flow into an interior 3, at least one controllable adjustment device 16 which adjusts an outflow direction of the air flow directed into the interior 3 and its target region, and at least one projection device 17 which generates and outputs at least one light beam 18. In this case, the at least one evaluation and control unit 14 controls the at least one controllable adjustment device 16 of the at least one air outlet 11 accordingly based on at least one user input and directs the air flow to the specified target region. The at least one evaluation and control unit 14 operates the at least one projection device 17 of the at least one air outlet 11 in different operating modes. The at least one projection device 17 of the at least one air outlet 11 generates the at least one light beam 18 with a high intensity as a spot light beam in a first operating mode and outputs it in such a way that the at least one light beam follows the direction of the output air flow and directly visualizes the air flow and generates at least one projection 19 at the target region of the air flow.

As can be further seen from FIG. 1, the air outlet arrangement 10 in the illustrated exemplary embodiment comprises multiple air outlets 11 which are arranged on an instrument panel 5. A first outlet 11A is arranged in the driver region on the left edge of the instrument panel 5. A second air outlet 11B is arranged in the driver region to the left of the center of the instrument panel 5. A third air outlet 11C is arranged in the passenger region to the right of the center of the instrument panel 5. A fourth air outlet 11D is arranged in the passenger region at the level of an unspecified glove compartment on the instrument panel 5. A fifth air outlet, not visible, is located in the passenger region on the right edge of the instrument panel 5.

As can be further seen from FIG. 1, in the illustrated exemplary embodiment of the air outlet arrangement 10, an operating device 7 designed as a touch screen 7A is arranged centrally on the instrument panel 5, separate from the air outlets 11. The operating device 7, designed as a touch screen 7A, receives the user inputs in a menu-guided manner and outputs corresponding operating signals to the evaluation and control unit 14, which then carries out the corresponding control of the adjustment devices 16 and projection devices 17 of the individual air outlets 11. Of course, other suitable embodiments for the operating device 7 are also possible in order to receive the user inputs.

As can further be seen from FIG. 2, the individual air outlets 11, of which only one air outlet 11 is shown as an example in FIG. 2, each comprise two controllable adjustment devices 16 and only one projection device 17. The projection device 17 functionally links the generated light beam 18 with a vector which represents the outflow direction of the air flow from the corresponding air outlet 11. To adjust the outflow direction of the air flow from the corresponding air outlet 11, a first adjustment device 16A enables a lateral deflection of the air flow to the left or right. A second adjustment device 16B enables the air flow to be deflected upwards or downwards. For this purpose, the two adjustment devices 16A, 16B can, for example, each comprise an actuator motor, not shown in detail, and corresponding air guide elements which are moved by the actuator motors.

In the illustrated exemplary embodiment, the air outlet arrangement 10 comprises only one evaluation and control unit 14, which controls the adjustment devices 16 and projection devices 17 of the individual air outlets 11. The evaluation and control unit 14 operates the projection devices 17 of the affected air outlets 11 during an adjustment process of the outflow direction of the air flow directed into the interior 3 in the first operating mode. This means that the evaluation and control unit 14 ends the first operating mode of the projection devices 17 of the affected air outlets 11 when the adjustment process of the outflow direction of the air flow of the affected air outlets 11 directed into the interior 3 is completed. In addition, after completion of the adjustment process, the evaluation and control unit 14 specifies a waiting time window before the first operating mode is terminated.

In the illustrated exemplary embodiment of the air outlet arrangement 10, the projection devices 17 of the affected air outlets 11 generate, in a second operating mode, the at least one light beam 18 respectively with a lower intensity as a diverging light beam and output it in such a way that the light beam 18 illuminates the air outlet opening 12 of the at least one air outlet 11 and no projection 19 is created. In the illustrated exemplary embodiment, the individual projection devices 17 visualize a set strength of the air flow emitted by the corresponding outlet 11 via the intensity of the at least one light beam 18 during the second operating mode. In the second operating mode, the maximum adjustable intensity is predetermined such that the at least one light beam 18 does not yet generate a projection 19. In addition, during the second operating mode, the individual projection devices 17 visualize a set temperature of the air flow emitted by the corresponding air outlet 11 via different color tones of the at least one light beam 18. In the illustrated embodiment, the evaluation and control unit 14 operates the individual projection devices 17 of the affected air outlets 11 in the second operating mode when the adjustment process of the outflow direction of the air flow to be emitted from the affected air outlets 11 has been completed and the first operating mode has ended.

In a third operating mode, the projection devices 17 of the affected air outlets 11 generate the at least one light beam 18 respectively with the high intensity and output it depending on a selected scenario with a constant output direction or with an output direction changing according to a predetermined movement pattern, so that at least one projection 19 can be generated in the interior 3. The evaluation and control unit 14 operates the projection devices 17 of the affected air outlets 11 before starting or after operation of the vehicle in the third operating mode. This means that the user can select a greeting or farewell scenario from various greeting or farewell scenarios, which is then executed by the evaluation and control unit 12 by appropriately controlling the projection devices 17 of the affected air outlets. For this purpose, projection devices 17 of the outlets 11 can each specify an output color of the generated at least one light beam 18.

In the illustrated exemplary embodiment of the air outlet arrangement 10, different colors are assigned to the plurality of air outlets 11A, 11B, 11C, 11D, so that the projection devices 17 of the individual air outlets 11 generate and output the corresponding at least one light beam 18 with the assigned color in the first operating mode.

FIG. 1 shows the air outlet arrangement 10 in a state in which the first air outlet 11A and the second air outlet 11B are each operated by the evaluation and control unit 14 in the first operating mode. As can be seen from FIG. 1, a first light beam 18A indicates in a first color the outflow direction of a first air flow of the first air outlet 11A, which is directed onto a chest of an occupant 9. The target region of the first air flow is indicated by a circular first projection 19A in the chest region of the occupant 9. A second light beam 18B indicates, in a second color different from the first, the outflow direction of a second air flow from the second air outlet 11B, which is also directed toward the chest of the occupant 9. The target region of the second air flow is indicated by a circular second projection 19B in the chest region of the occupant 9.

### LIST OF REFERENCE NUMERALS

1 vehicle
3 interior
5 instrument panel
7 operating device
7A touch screen
9 occupant
10 air outlet arrangement
11, 11A, 11B, 11C, 11D air outlet
12 air outlet opening
14 evaluation and control unit
16, 16A, 16B adjustment device
17 projection device
18, 18A, 18B light beam
19, 19A, 19B projection

1.-10. (canceled)

11. An air outlet arrangement for a vehicle, comprising: at least one air outlet and at least one evaluation and control unit, wherein the at least one air outlet comprises an air outlet opening designed to direct an air flow into an interior, at least one controllable adjustment device designed to adjust an outflow direction of the air flow directed into the interior and its target region, and at least one projection device designed to generate and output at least one light beam, wherein the at least one evaluation and control unit is designed to correspondingly control the at least one controllable adjustment device of the at least one air outlet based on at least one user input and to direct the air flow to the predetermined target region, wherein the evaluation and control unit is further designed to control the at least one projection device of the at least one air outlet in different operating modes, wherein the at least one projection device of the at least one outlet is designed to generate the at least one light beam with a high intensity as a spot light beam in a first operating mode and to output it in such a way that the at least one light beam follows the direction of the output air flow and directly visualizes the air flow and generates at least one projection at the target region of the air flow.

12. The air outlet arrangement according to claim 11, wherein the at least one evaluation and control unit is designed to operate the at least one projection device of the at least one air outlet in the first operating mode during an adjustment process of the outflow direction of the air flow directed into the interior.

13. The air outlet arrangement according to claim 11, wherein the at least one projection device of the at least one air outlet is further designed to generate the at least one light beam with a lower intensity as a diverging light beam in a second operating mode and to output it in such a way that the at least one light beam illuminates the air outlet opening of the at least one air outlet and no projection is created.

14. The air outlet arrangement according to claim 11, wherein the at least one projection device is further designed to generate the at least one light beam of the at least one air outlet with the high intensity in a third operating mode and to output it with a constant output direction or with an output direction changing according to a predetermined movement pattern, so that at least one projection can be generated in the interior.

15. The air outlet arrangement according to claim 14, wherein the at least one evaluation and control unit can be designed to operate the at least one projection device before starting or after operation of the vehicle in the third operating mode.

16. The air outlet arrangement claim 11, wherein the at least one projection device of the at least one air outlet is further designed to specify an output color of the generated at least one light beam.

17. The air outlet arrangement according to claim 16, wherein the at least one projection device is designed to visualize a set strength of the air flow emitted by the at least one air outlet via the intensity of the at least one light beam during the second operating mode.

18. The air outlet arrangement according to claim 16, wherein the at least one projection device is designed to visualize a set temperature via different color tones of the at least one light beam during the second operating mode.

19. The air outlet arrangement according to claim 16, wherein different colors are assigned to multiple air outlets, so that the projection devices of the individual air outlets generate and output the corresponding at least one light beam with the assigned color during the first operating mode.

20. The air outlet arrangement according to claim 11, wherein at least one operating device, which is arranged separately from the at least one outlet, is designed to receive the at least one user input and to output at least one corresponding operating signal to the evaluation and control unit.

21. The air outlet arrangement according to claim 12, wherein the at least one projection device of the at least one air outlet is further designed to generate the at least one light beam with a lower intensity as a diverging light beam in a second operating mode and to output it in such a way that the at least one light beam illuminates the air outlet opening of the at least one air outlet and no projection is created.

22. The air outlet arrangement according to claim 12, wherein the at least one projection device is further designed to generate the at least one light beam of the at least one air outlet with the high intensity in a third operating mode and to output it with a constant output direction or with an output direction changing according to a predetermined movement pattern, so that at least one projection can be generated in the interior.

23. The air outlet arrangement according to claim 13, wherein the at least one projection device is further designed to generate the at least one light beam of the at least one air outlet with the high intensity in a third operating mode and to output it with a constant output direction or with an output direction changing according to a predetermined movement pattern, so that at least one projection can be generated in the interior.

24. The air outlet arrangement according to claim 12, wherein the at least one projection device is further designed to generate the at least one light beam of the at least one air outlet with the high intensity in a third operating mode and to output it with a constant output direction or with an output direction changing according to a predetermined movement pattern, so that at least one projection can be generated in the interior.

25. The air outlet arrangement according to claim 13, wherein the at least one projection device is further designed to generate the at least one light beam of the at least one air outlet with the high intensity in a third operating mode and to output it with a constant output direction or with an output direction changing according to a predetermined movement pattern, so that at least one projection can be generated in the interior.

26. The air outlet arrangement according to claim 14, wherein the at least one projection device is further designed to generate the at least one light beam of the at least one air outlet with the high intensity in a third operating mode and to output it with a constant output direction or with an output direction changing according to a predetermined movement pattern, so that at least one projection can be generated in the interior.

27. The air outlet arrangement according to claim 15, wherein the at least one projection device is further designed to generate the at least one light beam of the at least one air outlet with the high intensity in a third operating mode and to output it with a constant output direction or with an output direction changing according to a predetermined movement pattern, so that at least one projection can be generated in the interior.

28. The air outlet arrangement according to claim 17, wherein the at least one projection device is designed to visualize a set temperature via different color tones of the at least one light beam during the second operating mode.

29. The air outlet arrangement according to claim 12, wherein at least one operating device, which is arranged separately from the at least one outlet, is designed to receive the at least one user input and to output at least one corresponding operating signal to the evaluation and control unit.

30. The air outlet arrangement according to claim 13, wherein at least one operating device, which is arranged separately from the at least one outlet, is designed to receive the at least one user input and to output at least one corresponding operating signal to the evaluation and control unit.
